(19) United States
(12) Patent Application Publication
(10) Pub. No.: US 2020/0175432 A1
(43) Pub. Date: Jun. 4, 2020

(54) TRAVEL SCHEDULE DETERMINATION DEVICE, AUTONOMOUS VEHICLE, TRAVEL SCHEDULE DETERMINATION METHOD, AND PROGRAM

(71) Applicant: HONDA MOTOR CO., LTD., Minato-ku, Tokyo (JP)

(72) Inventors: Shun Iwasaki, Wako-shi (JP); Takafumi Hirose, Wako-shi (JP); Nobuyuki Watanabe, Wako-shi (JP); Jun Ito, Wako-shi (JP); Rie Fukushima, Wako-shi (JP); Hisakazu Yamane, Tokyo (JP); Masaaki Onoda, Tokyo (JP)

(21) Appl. No.: 16/621,461

(22) PCT Filed: Jun. 14, 2018
(86) PCT No.: PCT/JP2018/022734

§ 371 Date: Dec. 11, 2019

(30) Foreign Application Priority Data
Jun. 16, 2017 (JP) 2017-118914

(51) Int. Cl. G06Q 10/02; G06Q 10/04; G06Q 50/30; G01C 21/34; B60R 25/24; G05D 1/02

(52) U.S. Cl. CPC G06Q 10/02; G06Q 10/047; G06Q 50/30; G05D 2201/0212; B60R 25/24; G05D 1/0212; G01C 21/343

(57) ABSTRACT

A travel schedule determining device includes: an acquirer that acquires schedule information of a plurality of users and attribute information indicating a mutual relationship between some users out of the plurality of users; and a determiner that determines a travel schedule of an automated-driving vehicle on the basis of the information acquired by the acquirer.

### TECHNICAL FIELD

The invention relates to a travel schedule determining device, an automated-driving vehicle, a travel schedule determining method, and a program.

Priority is claimed on Japanese Patent Application No. 2017-118914, filed Jun. 16, 2017, the content of which is incorporated herein by reference.

### BACKGROUND ART

In the related art, an invention of an autonomously traveling vehicle including a means that is used for a user to designate departure point coordinates, destination point coordinates, and a use time, a route planning means that plans a route from the departure point coordinates to the destination point coordinates, a travel plan information calculating means that calculates a distance and a time for traveling on the route which is planned by the route planning means, a reservation managing means that calculates energy required for travel on the basis of the information calculated by the travel plan information calculating means, determines whether an autonomously traveling vehicle is able to travel on the route on the basis of the result of calculation, the use time, and an estimated energy residual of the autonomously traveling vehicle, and manages a travel reservation of the autonomously traveling vehicle, an information input means that is used for a user to designate point names of a departure point and a destination point and to designate a margin time, a point information database that correlates the point names with point coordinates, and a point coordinates retrieving means that retrieves the departure point coordinates and the destination point coordinates from the point information database on the basis of the departure point names and the destination point names which are designated by the user is disclosed (for example, see Patent Literature 1).

### CITATION LIST

### Patent Literature

### Patent Literature 1

PCT International Publication No. WO 2014/024254

### SUMMARY OF INVENTION

### Technical Problem

However, in the related art, since a mutual relationship between users who board together is not considered, a travel schedule matching the mutual relationship between users may not be determined.

The invention is made in consideration of the above-mentioned circumstances and an object thereof is to provide a travel schedule determining device, an automated-driving vehicle, a travel schedule determining method, and a program that can determine a travel schedule which matches a mutual relationship between users.

### Solution to Problem

A travel schedule determining device, an automated-driving vehicle, a travel schedule determining method, and a program according to the invention employ the following configurations.

(1) A travel schedule determining device according to an aspect of the invention is a travel schedule determining device (300) including: an acquirer (320) that acquires schedule information of a plurality of users and attribute information indicating a mutual relationship between some users out of the plurality of users; and a determiner (330) that determines a travel schedule of an automated-driving vehicle on the basis of the information acquired by the acquirer.

(2) In the aspect of (1), the determiner may determine the travel schedule with reference to the attribute information such that a user who requires care and a user who provides care board the automated-driving vehicle together.

(3) In the aspect of (2), the user who requires care may be a child and the user who provides care may be a user who is not a child.

(4) In the aspect of (1), the determiner may determine the travel schedule such that an article which is loaded by an occupation-permitted user who occupies at least a part of the automated-driving vehicle and an owner of the article are both in the automated-driving vehicle.

(5) In any one of the aspects of (1) to (4), the acquirer may acquire change information of the schedule information, and the determiner may dynamically change the travel schedule on the basis of the change information.

(6) In any one of the aspects of (1) to (4), the determiner may determine the travel schedule on the basis of attributes of the automated-driving vehicle such that boarding of a user who requires care alone in the automated-driving vehicle is permitted.

(7) In any one of the aspects of (1) to (5), the determiner may generate one or more candidates for the travel schedule, calculate a score based on a waiting time of a user or an arrival delay time for the one or more candidates for the travel schedule, and determine a candidate for the travel schedule on the basis of the calculated score.

(8) The travel schedule determining device according to any one of the aspects of (1) to (6) may further include a communicator (310) that communicates with a terminal device of a user, the determiner may generate one or more candidates for the travel schedule, the communicator may transmit the candidates for the travel schedule generated by the determiner to the terminal device, and the determiner may determine the travel schedule on the basis of a result of selection of the travel schedule by the user received from the terminal device using the communicator.

(9) An automated-driving vehicle according to an aspect of the invention is an automated-driving vehicle that is communicatively connected to a travel schedule determining device including an acquirer that acquires schedule information of a plurality of users and attribute information indicating a mutual relationship between some users out of the plurality of users and a determiner that determines a travel schedule of the automated-driving vehicle on the basis of the information acquired by the acquirer, the automated-driving vehicle including: a route generator (280) that generates a travel plan including route information on the basis of the travel schedule determined by the travel schedule determining device; an automated driving controller (250) that sets an attribute travel plan in which the travel plan generated by the route generator and the attribute information are correlated with each other and causes the automated-driving vehicle to travel along a route in the set attribute travel plan; a sensor that detects the attribute information; and a comparer (284) that compares the attribute travel plan with the attribute information detected by the sensor when the automated-driving vehicle travels under the control of the automated driving controller.

(10) In the aspect of (9), the attribute travel plan may include an occupation plan for allowing each of the plurality of users to occupy a part of the automated-driving vehicle.

(11) The automated-driving vehicle according to the aspect of (10) may further include: an authenticator (286) that acquires key information for occupying a part of the automated-driving vehicle and authenticates a user using the acquired key information; and a vehicle access manager (288) that permits occupation of at least a part of the automated-driving vehicle when authentication by the authenticator has been performed successfully, and the vehicle access manager may permit occupation of a part of the automated-driving vehicle when access permission information acquired by the determiner matches the key information and reset the attribute travel plan when the access permission information does not match the key information.

(12) The automated-driving vehicle according to any one of the aspects of (9) to (11) may further include a notification device (290) that notifies the determiner of a time which is not included in the attribute travel plan, and the route generator may change the travel plan on the basis of a new travel schedule which is determined on the basis of notification information transmitted from the notification device and travel permission information which is set for the automated-driving vehicle.

(13) A travel schedule determining method according to an aspect of the invention is a travel schedule determining method causing a computer to perform: acquiring schedule information of a plurality of users and attribute information indicating a mutual relationship between some users out of the plurality of users; and determining a travel schedule of an automated-driving vehicle on the basis of the acquired schedule information and the acquired attribute information.

(14) A program according to an aspect of the invention is a program causing a computer to perform: acquiring schedule information of a plurality of users and attribute information indicating a mutual relationship between some users out of the plurality of users; and determining a travel schedule of an automated-driving vehicle on the basis of the acquired schedule information and the acquired attribute information.

### Advantageous Effects of Invention

According to the aspects of (1) to (14), the travel schedule determining device 300 can determine a travel schedule which matches a mutual relationship between users.

According to the aspects of (2) and (3), for example, since a user who provides care boards together with a user who requires care such as a child, it is possible to reduce discomfort based on boarding of a user alone who requires care.

According to the aspect of (5), since the travel schedule is dynamically changed when a user changes the schedule information, it is possible to enhance convenience for a user.

According to the aspect of (6), the travel schedule determining device 300 can determine a travel schedule which matches schedules of the users on the basis of attributes of the automated-driving vehicle.

According to the aspect of (8), the travel schedule determining device 300 can cause a terminal device 100 to display a plurality of candidates for a travel schedule as the travel schedule and cause a user to determine a favorite travel schedule.

### BRIEF DESCRIPTION OF THE DRAWINGS

FIG. 1 is a diagram showing a configuration of a vehicle system 1 including a travel schedule determining device 300 according to a first embodiment;

FIG. 2 is a diagram showing a configuration of a vehicle 200 according to the first embodiment;

FIG. 3 is a diagram showing an automated driving processing routine;

FIG. 4 is a diagram showing an example of content of user schedule information 352;

FIG. 5 is a diagram showing an example of content of inter-user attribute information 353;

FIG. 6 is a diagram showing an example for determining one travel schedule from a plurality of candidates for a travel schedule;

FIG. 7 is a diagram showing an example of content of travel schedule information 354;

FIG. 8 is a diagram showing an example of vehicle control with travel schedule ID “D001”;

FIG. 9 is a diagram showing an example of vehicle control with travel schedule ID “D002”;

FIG. 10 is a diagram showing an example of vehicle control with travel schedule ID “D003”;

FIG. 11 is a diagram showing an example of vehicle control with travel schedule ID “D004”;

FIG. 12 is a diagram showing an example of vehicle control in a changed travel schedule;

FIG. 13 is a flowchart showing an example of a process flow which is performed by the travel schedule determining device 300 according to the first embodiment;

FIG. 14 is a diagram showing a configuration of a vehicle 200A according to a second embodiment; and

FIG. 15 is a diagram showing a configuration of a vehicle 200B according to a third embodiment.

### DESCRIPTION OF EMBODIMENTS

Hereinafter, embodiments of a travel schedule determining device, an automated-driving vehicle, a travel schedule determining method, and a program according to the invention will be described with reference to the accompanying drawings. A travel schedule determining device is a device that allocates a vehicle to a desired user and transports the user to a destination. Such a vehicle is, for example, an automated-driving vehicle that does not basically require a driving operation. An automated-driving vehicle is used in the following embodiments, but a manual-driving vehicle may be used.

### First Embodiment

[Entire Configuration]

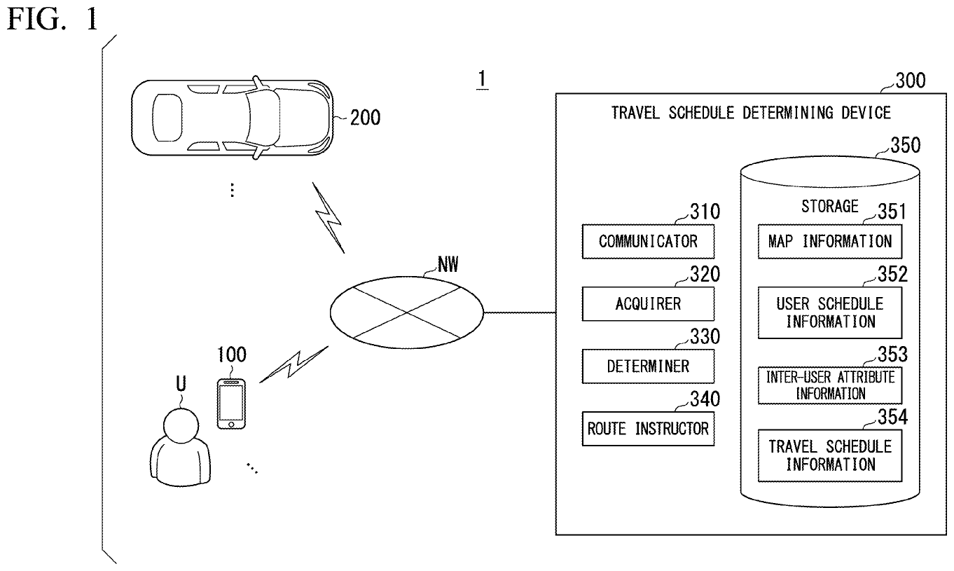

FIG. 1 is a diagram showing a configuration of a vehicle system 1 including a travel schedule determining device 300 according to a first embodiment. The vehicle system 1 includes one or more terminal devices 100 which are used by one or more users U, one or more vehicles 200, and a travel schedule determining device 300. These elements can communicate with each other via a network NW. The network NW includes the Internet, a wide area network (WAN), a local area network (LAN), a public circuit, a provider device, a dedicated circuit, and a radio base station. “Being used by a user U” may include that a terminal device which can be used by many and unspecified persons such as a terminal device in a net café is temporarily used by a user U.

[Terminal Device]

A terminal device 100 is, for example, a smartphone, a tablet terminal, or a personal computer. In the terminal device 100, an application program, a browser, or the like for using the vehicle system 1 is started to support a travel schedule determining service which will be described below, or the like. In the following description, it is assumed that the terminal device 100 is a smartphone and an application program (a travel schedule determining application) is started. The travel schedule determining application communicates with the travel schedule determining device 300 in response to a user U's operation, and transmits schedule information of the user U or attribute information indicating a mutual relationship between at least some users out of a plurality of users to the travel schedule determining device 300 or performs push notification based on information received from the travel schedule determining device 300.

[Vehicle]

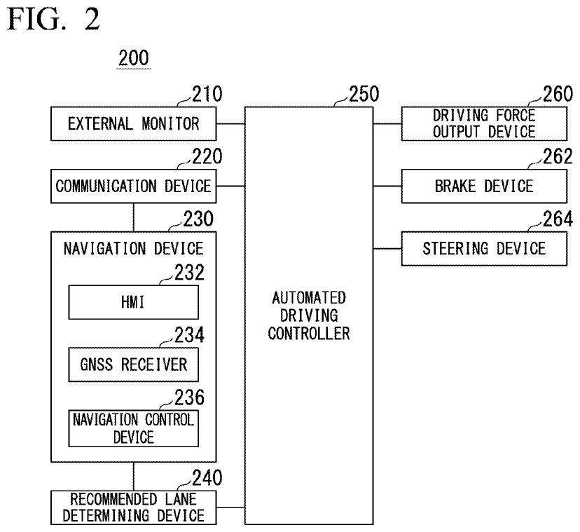

The vehicle 200 is, for example, a vehicle with four or more wheels on which a plurality of users U can board, and may be an automated motorbike or other vehicle. FIG. 2 is a diagram showing a configuration of the vehicle 200 according to the first embodiment. The vehicle 200 includes, for example, an external monitor 210, a communication device 220, a navigation device 230, a recommended lane determining device 240, an automated driving controller (an example of an automated driving controller) 250, a driving force output device 260, a brake device 262, and a steering device 264. The automated driving controller 250 includes, for example, a processor such as a central processing unit (CPU) that executes a program (software) which is stored in a storage (not shown) in the vehicle 200.

The external monitor 210 includes, for example, a camera, a radar, a Light Detection and Ranging (LIDAR) device, and an object recognizing device that performs sensor fusion processing on the basis of outputs therefrom. The external monitor 210 estimates a type of an object (particularly, a vehicle, a pedestrian, and a bicycle) which is near the vehicle 200, and outputs a result of estimation to the automated driving controller 250 along with information of a position or a speed thereof.

The communication device 220 is, for example, a radio communication module that accesses a network NW or directly communicates with another vehicle, a terminal device of a pedestrian, or the like. The communication device 220 performs radio communication on the basis of a communication standard such as Wi-Fi, dedicated short range communication (DSRC), or Bluetooth (registered trademark). A plurality of communication devices for usage may be provided as the communication device 220.

The navigation device 230 includes, for example, a human-machine interface (HMI) 232, a global navigation satellite system (GNSS) receiver 234, and a navigation control device 236. The HMI 232 includes, for example, a touch panel display device, a speaker, and a microphone. The GNSS receiver 234 identifies a position of the host device (a position of the vehicle 200) on the basis of radio waves received from GNSS satellites (for example, GPS satellites). The navigation control device 236 includes, for example, a CPU or various storage devices and controls the navigation device 230 as a whole. Map information (a navigation map) is stored in the storage device. The navigation map is a map in which each road is expressed by nodes and links.

The navigation control device 236 determines a route from the position of the vehicle 200 identified by the GNSS receiver 234 to a destination which is designated by the HMI 232 with reference to the navigation map. The navigation control device 236 may transmit the position of the vehicle 200 and the destination to a navigation server (not shown) using the communication device 220 and acquire a route which is returned from the navigation server.

In the first embodiment, a route may be designated by the travel schedule determining device 300. Each route may include information of points at which the vehicle 200 stops to allow a user to enter or exit the vehicle and target arrival times thereof (for example, a travel plan).

The navigation control device 236 outputs information of a route which is determined using one of the above-mentioned methods to the recommended lane determining device 240.

The recommended lane determining device 240 includes, for example, a map positioning unit (MPU) and various storage devices. Map information with higher precision than the navigation map is stored in the storage device. The map information with high precision includes information such as a road width, a gradient, a curvature for each lane and positions of traffic signals. The recommended lane determining device 240 determines a recommended lane which is suitable for the vehicle to travel along a route input from the navigation device 230 and outputs the determined recommended lane to the automated driving controller 250.

The automated driving controller 250 includes one or more processors such as a CPU or an MPU and various storage devices. The automated driving controller 250 causes the automated-driving vehicle to travel in a recommended lane determined by the recommended lane determining device 240 in principles and causes the vehicle 200 to travel automatically such that contact with an object of which the position or the speed is input from the external monitor 210 is avoided. For example, the automated driving controller 250 sequentially performs various events. The events include a constant-speed travel event in which the vehicle travels in a travel lane at a constant speed, a following travel event in which a vehicle travels to follow a preceding vehicle, a lane change event, a merging event, a branching event, an emergency stop event, a toll gate event in which a vehicle passes through a toll gate, and a handover event in which automated driving ends and is switched to manual driving. During execution of such events, behavior for avoidance may be planned on the basis of surrounding circumstances of the vehicle 200 (such as presence of a neighboring vehicle or a pedestrian and lane narrowing due to roadwork).

The automated driving controller 250 generates a target path on which the vehicle 200 will travel in the future. A target path includes, for example, a speed element. For example, a target path is expressed by sequentially arranging points (path points) at which the vehicle 200 will arrive. The path points are points at which the vehicle 200 is to arrive at intervals of a predetermined traveling distance, and a target speed and a target acceleration at intervals of a predetermined sampling time (for example, several below the decimal point [sec]) are generated as a part of a target path in addition. Path points may be positions at which the vehicle 200 is to arrive at sampling times every predetermined sampling time. In this case, information of a target speed or target acceleration is expressed by intervals of the path points.

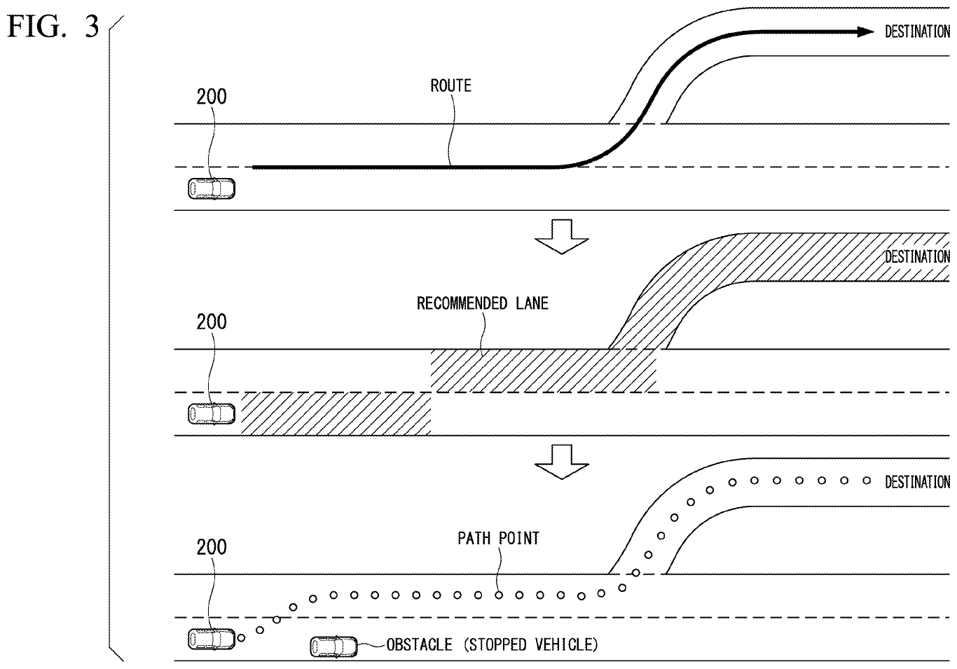

FIG. 3 is a diagram showing an automated driving processing routine. First, as shown in the upper part of the drawing, a route is determined by the navigation device 230. This route is, for example, a rough route in which lanes are not distinguished. Then, as shown in the middle part, the recommended lane determining device 240 determines a recommended lane in which the vehicle can easily travel along the route. Then, as shown in the lower part, the automated driving controller 250 generates path points for allowing the vehicle to travel along the recommended lane as much as possible while avoiding an obstacle or the like and controls some or all of the driving force output device 260, the brake device 262, and the steering device 264 such that the vehicle travels along the path points (and incidental speed profiles). This role assignment is only an example and, for example, the automated driving controller 250 may perform the processes unitarily.

The driving force output device 260 outputs a travel driving force (a torque) for allowing a vehicle to travel to driving wheels. The driving force output device 260 includes, for example, a combination of an internal combustion engine, an electric motor, and a transmission and a power ECU that controls them. The power ECU controls the above-mentioned configuration on the basis of information input from the automated driving controller 250 or information input from a driving operator which is not illustrated.

The brake device 262 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of information input from the automated driving controller 250 or information input from the driving operator such that a brake torque based on a braking operation is output to vehicle wheels. The brake device 262 may include a mechanism for transmitting a hydraulic pressure generated by an operation of a brake pedal included in the driving operator to the cylinder via a master cylinder as a backup. The brake device 262 is not limited to the above-mentioned configuration, and may be an electronically controlled hydraulic brake device that controls an actuator on the basis of information input from the automated driving controller 250 such that the hydraulic pressure of the master cylinder is transmitted to the cylinder.

The steering device 264 includes, for example, a steering ECU and an electric motor. The electric motor changes a direction of turning wheels, for example, by applying a force to a rack-and-pinion mechanism. The steering ECU drives the electric motor on the basis of information input from the automated driving controller 250 or information input from the driving operator to change the direction of the turning wheels.

[Travel Schedule Determining Device]

Referring back to FIG. 1, the travel schedule determining device 300 includes, for example, a communicator 310, an acquirer 320, a determiner 330, a route instructor 340, and a storage 350. The acquirer 320, the determiner 330, and the route instructor 340 are realized, for example, by causing a processor such as a CPU to execute a program (software) stored in the storage 350. Some or all of these functions may be realized in hardware such as a large scale integration (LSI), an application specific integrated circuit (ASIC), or a field-programmable gate array (FPGA) or may be realized by software and hardware in cooperation. The program may be stored in a storage device (for example, the storage 350) such as a hard disk drive (HDD) or a flash memory in advance, or the program may be stored in a detachable storage medium such as a DVD or a CD-ROM and installed in the storage device by inserting the storage medium into a drive device (not shown).

The communicator 310 is, for example, a network card for connection to the network NW. The communicator 310 communicates with a terminal device 100 or a vehicle 200 via the network NW.

The acquirer 320 acquires, for example, schedule information and attribute information of a plurality of users who use the travel schedule determining service in the vehicle system 1.

For example, the acquirer 320 acquires schedule information and attribute information which are input by a user operating a travel schedule determining application which is executed in a terminal device 100 connected thereto via the network NW. The acquirer 320 may acquire schedule information of a user which is input to a scheduler application or a scheduling site which is provided by an application server (not shown) or a web server (not shown) connected to the network NW.

The acquirer 320 stores the acquired schedule information and the acquired attribute information as user schedule information 352 and inter-user attribute information 353 in the storage 350.

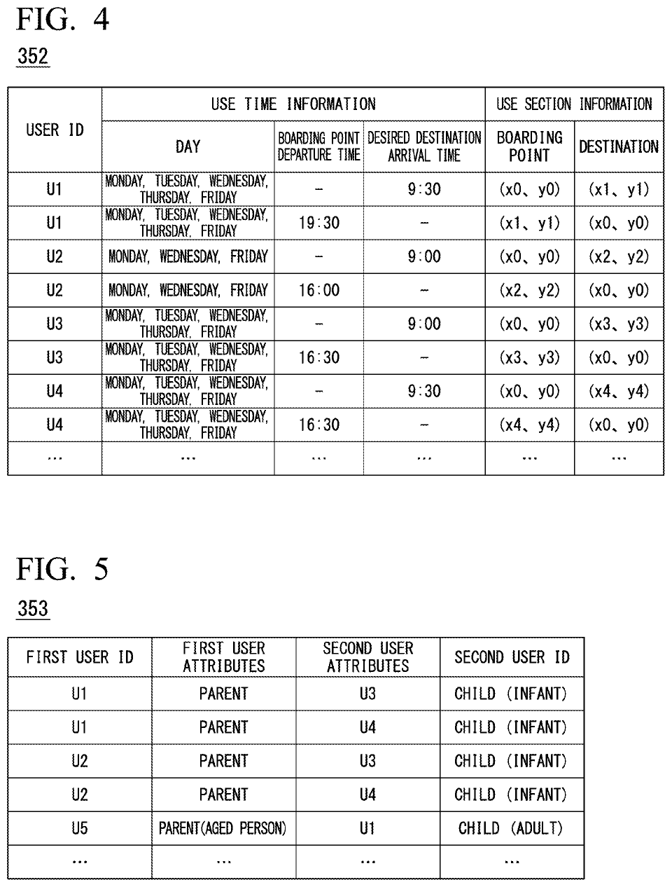

FIG. 4 is a diagram showing an example of content of the user schedule information 352. The user schedule information 352 is information in which use time information and use section information are correlated with a user ID which is identification information of a user who uses the vehicle 200. The use time information includes a day on which a user is scheduled to use the vehicle 200 and one or both of a boarding point departure time and a desired destination arrival time. The use section information includes a position of a boarding point and a position of a destination. The positions of the boarding point and the destination are expressed by coordinates which are correlated with the map information 351. The user schedule information 352 may include specific date and time information in addition to (or instead of) the schedule information shown in FIG. 4 or may include information for specifying time in which there is no user.

FIG. 5 is a diagram showing an example of content of the inter-user attribute information 353. The inter-user attribute information 353 is an example of attribute information indicating a mutual relationship between users. In the inter-user attribute information 353, a set of a second user ID and second user attributes is correlated with a set of a first user ID and first user attributes. The first user attributes are attributes of a user who is identified by the first user ID which is defined for a user who is identified by the second user ID. The second user attributes are attributes of the user who is identified by the second user ID which is defined for the user who is identified by the first user ID.

The inter-user attribute information 353 includes at least information indicating a relationship between a user who requires care and a user who provides care. Users who require care include, for example, children. Children include at least infants. In this case, a user who provides care is, for example, a parent of an infant. A parent is a user who is not a child.

A user who requires care may be an aged person. In this case, a user who provides care is, for example, an (adult) child of the aged person. A user who requires care may be a disabled person who has a disability such as a physical disability, an intellectual disability, or a mental disability. In this case, a user who provides care is, for example, a parent or an (adult) brother or sister of the disabled person. The inter-user attribute information 353 shown in FIG. 5 indicates attributes between users who can board together, but may indicate attributes between users who are prohibited from boarding together. The attributes between users who are prohibited from boarding together are, for example, attributes in which both a first user and a second user require care.

The inter-user attribute information 353 may include a relationship between an owner who owns or manages the vehicle 200 and an occupation-permitted user who is permitted to occupy the vehicle 200 or may include a relationship between the owner and a permitted service. Examples of the occupation-permitted user include a friend or an acquaintance of the owner and a service provider. Examples of the permitted service include a delivery service such as home delivery and a passenger compartment cleaning service or a maintenance service of the vehicle 200. A user in the inter-user attribute information 353 may be a user himself or herself (a person) or may be an article (such as luggage) which is loaded in the vehicle 200 by a user (an occupation-permitted user).

The determiner 330 determines a travel schedule of the vehicle 200 on the basis of the map information 351, and the user schedule information 352 and the inter-user attribute information 353 acquired by the acquirer 320. The determiner 330 stores the determined travel schedule as travel schedule information 354 in the storage 350. Details of the function of the determiner 330 will be described later.

The route instructor 340 transmits an instruction for a route based on the travel schedule determined by the determiner 330 to the vehicle 200. Details of the function of the route instructor 340 will be described later.

The storage 350 is realized by an HDD, a flash memory, a random access memory (RAM), a read only memory (ROM), or the like. For example, the storage 350 stores the map information 351, the user schedule information 352, the inter-user attribute information 353, the travel schedule information 354, and other information.

The map information 351 may include, for example, road information, traffic regulation information, address information (addresses and postal codes), facility information, and phone number information. The road information includes information indicating types of roads such as an expressway, a toll road, a national road, and a prefectural road or information such as the number of lanes on each road, an area of an emergency parking zone, a width of each lane, a gradient of each road, a position of each road (three-dimensional coordinates including longitude, latitude, and height), curvatures of curves of each lane, positions of merging and branching points of lanes, and traffic signs marked on each road. The map information 351 may be updated from time to time by accessing another device using the communication device 220.

[Travel Schedule Determining Service According to First Embodiment]

An example of a travel schedule determining service according to the first embodiment will be described below. The travel schedule determining service is a service of transporting one or more users in a section between a home and a destination, for example, using a vehicle 200. A destination is, for example, a place which is designated by a user such as a company, an orphanage, a school, a private institute, or a hospital. In the following description, it is assumed that users U1 to U4 use the travel schedule determining service of the vehicle 200. In addition, for example, it is also assumed that the users U1 to U4 are family members who live together.

First, the users U1 to U4 access the travel schedule determining device 300 and register schedules and attribute information of the users U1 to U4 who are provided with the travel schedule determining service by operating a travel schedule determining application which is executed by the terminal device 100. The schedules and the attribute information of the users U1 to U4 may be registered at a time by a representative user (for example, the user U1) or may be registered by each of the users U1 to U4.

The acquirer 320 stores the schedules and the inter-user attribute information input through the terminal device 100 as the user schedule information 352 and the inter-user attribute information 353 in the storage 350.

The determiner 330 determines a travel schedule on the basis of the map information 351 and the user schedule information 352. For example, when a user is transported from a departure point to a destination, the determiner 330 determines a travel schedule such that the vehicle arrives at a boarding point at a boarding point departure time and arrives at a destination at a desired destination arrival time. When the vehicle cannot arrive at the boarding point departure time or the desired destination arrival time, the determiner 330 determines, for example, the travel schedule such that a waiting time of a user until the vehicle 200 arrives at the boarding point or an arrival delay time at the destination is shorter than a predetermined time or is as short as possible.

The determiner 330 determines the travel schedule such that at least one of the users U1 and U2 boards together when the user U3 or U4 boards. The determiner 330 may determine the travel schedule such that movement by free running (running with no boardrs) is limited at the time of movement of the vehicle 200. In this case, the determiner 330 may determine the travel schedule such that the vehicle 200 is towed and moved using another vehicle or is driven by a driver other than the users. The determiner 330 may determine the travel schedule such that the vehicle 200 is manually driven in some sections. The determiner 330 may determine the travel schedule on the basis of the inter-user attribute information 353 such that an article which is loaded on a seat or in a luggage space in the vehicle 200 by a user who occupies at least a part of the vehicle 200 (an occupation-permitted user) and an owner of the article are both in the vehicle 200.

For example, when one or more candidates for the travel schedule satisfying the above-mentioned conditions are generated, the determiner 330 calculates a score based on a waiting time of a user or an arrival delay time for each of the generated candidates for the travel schedule. For example, the determiner 330 calculates the score such that the score decreases as the waiting time of the user or the arrival delay time becomes longer than a reference value (for example, 0). Then, the determiner 330 determines the travel schedule such that the calculated score is higher than those of the other candidates.

The determiner 330 may calculate a cost depending on the number of vehicles which travel according to the travel schedule. For example, when a travel schedule in which a plurality of users board a plurality of different vehicles is generated, the determiner 330 calculates a score which decreases depending on the number of vehicles.

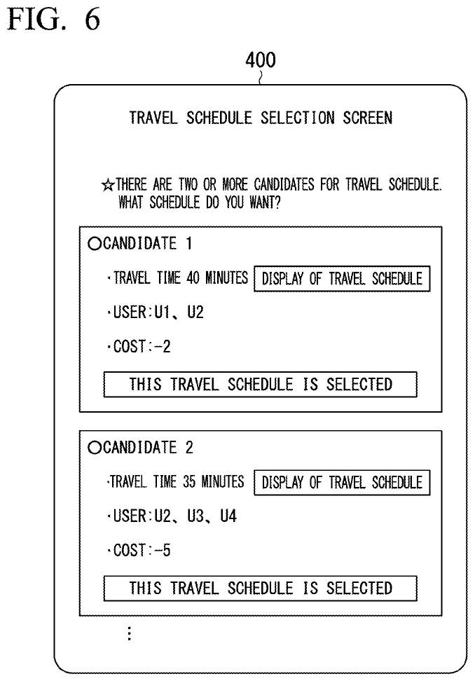

For example, when one or more candidates for the travel schedule satisfying the above-mentioned conditions are generated, the determiner 330 may determine the travel schedule by transmitting the generated candidates to the terminal device 100 and allowing a user to select any one candidate for the travel schedule. FIG. 6 is a diagram showing an example in which a travel schedule is determined out of a plurality of candidates for the travel schedule. When a travel schedule is allowed to be selected by a user, the determiner 330 displays a travel schedule selection screen 400 shown in FIG. 6 on the terminal device 100.

On the travel schedule selection screen 400, information on the one or more candidates for the travel schedule generated by the determiner 330 is displayed. The information on the candidates for the travel schedule includes, for example, information of travel time, a user who boards, and a cost. The candidates for the travel schedule are displayed on the travel schedule selection screen 400 in a predetermined order such as the order of travel times or the order of costs.

On the travel schedule selection screen 400, display buttons indicating the travel schedules of the candidates, decision buttons for determining the travel schedules, and the like are displayed. When selection of a display button by a user is accepted, the determiner 330 displays the travel schedule of the corresponding candidate on the screen of the terminal device 100. When selection of a decision button by a user is accepted, the determiner 330 determines the selected candidate as the travel schedule.

In this way, the determiner 330 can determine a travel schedule which is desired by a user by displaying a plurality of candidates for the travel schedule as recommended travel schedules on the terminal device 100 and allowing a user to select one candidate using the travel schedule selection screen 400.

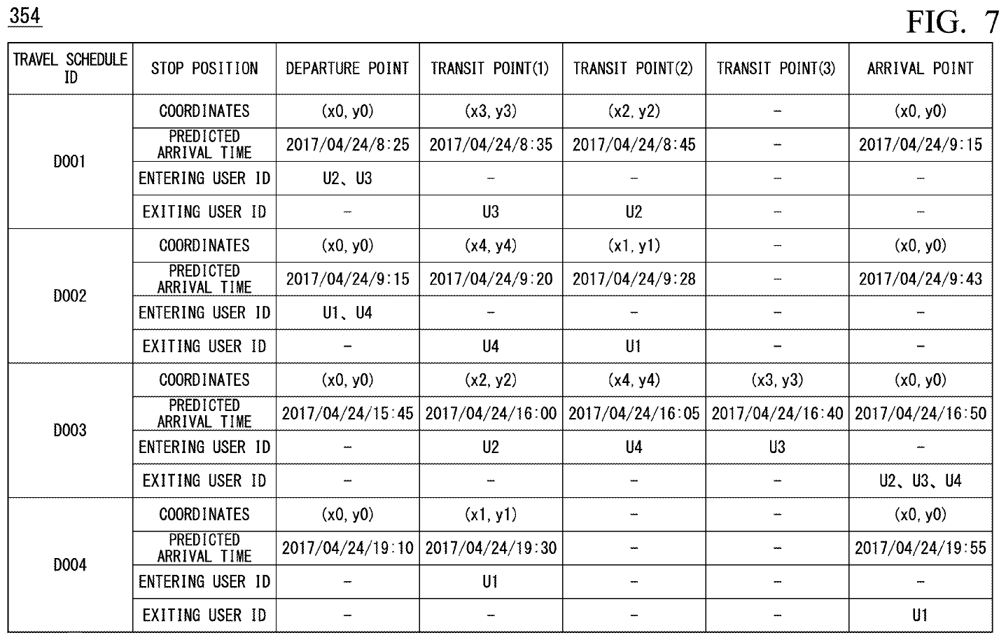

The determiner 330 stores the determined schedule as the travel schedule information 354 in the storage 350. FIG. 7 is a diagram showing an example of content of the travel schedule information 354. In the travel schedule information 354, stop positions (coordinates), scheduled arrival times, entering users, and exiting users are correlated with a travel schedule ID. The stop positions include information of a departure point, transit points, and an arrival point. In the example shown in FIG. 7, the departure point and the arrival point of the vehicle 200 are positions (x0, y0) of the home, and the scheduled arrival time at the departure point is a departure time of the vehicle 200.

In the example shown in FIG. 7, travel schedules D001 to D004 are determined as the travel schedule information 354 corresponding to one day of April 24 (Monday), 2017. The route instructor 340 transmits the travel schedule information 354 to the vehicle 200. The determiner 330 may transmit access permission information of users for each section to the vehicle 200 or terminals carried by the users at a time equal to or different from the time at which the travel schedule information 354 is transmitted to the vehicle 200 by the route instructor 340. The vehicle 200 travels by automated driving on the basis of the received travel schedule information 354.

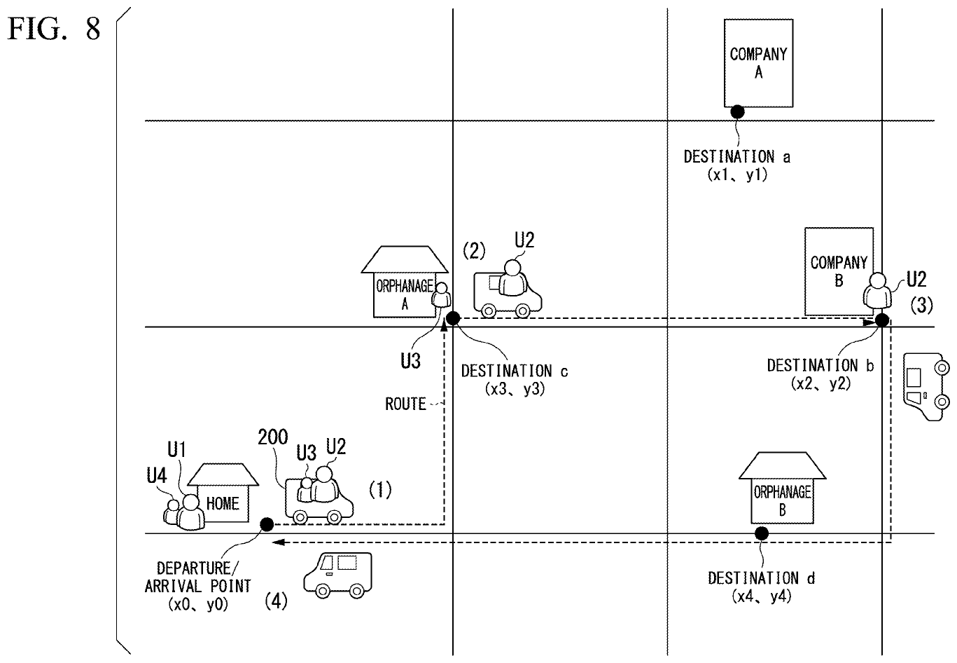

FIG. 8 is a diagram showing an example of vehicle control with travel schedule ID “D001.” In vehicle control with travel schedule ID “D001,” the vehicle 200 departs from the home (x0, y0) in a state in which the users U2 and U3 board together at a departure time, and stops at a destination c (x3, y3) at which orphanage A is located. The user U3 exits at the destination c, and then the vehicle 200 stops at a destination b (x2, y2) at which company B is located. The user U2 exits at the destination b, and then the vehicle 200 travels to the home and stops after arriving at the home.

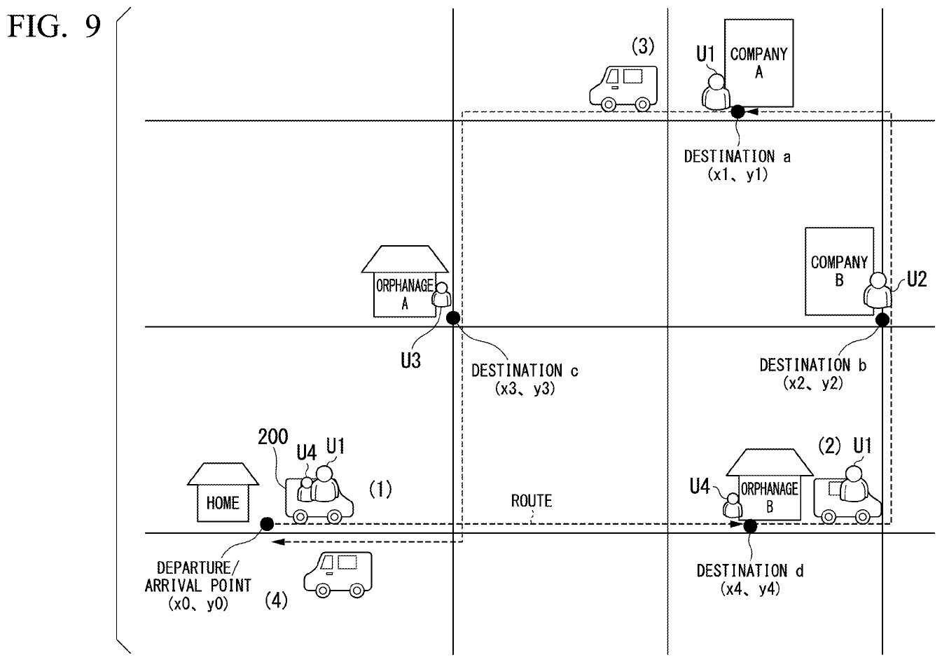

FIG. 9 is a diagram showing an example of vehicle control with travel schedule ID “D002.” The travel schedule shown in FIG. 9 is a schedule which is executed after travel with travel schedule ID “D001” has ended. In vehicle control with travel schedule ID “D002,” the vehicle 200 departs from the home (x0, y0) in a state in which the users U1 and U4 board together at a departure time, and stops at a destination d (x4, y4) at which orphanage B is located. The user U4 exits at the destination d, and then the vehicle 200 stops at a destination a (x1, y1) at which company A is located. The user U1 exits at the destination a, and then the vehicle 200 travels to the home and stops at a garage of the home. The vehicle 200 can transport the users U1 to U4 from the home to the destinations by traveling on the routes corresponding to travel schedule IDs “D001” and “D002.”

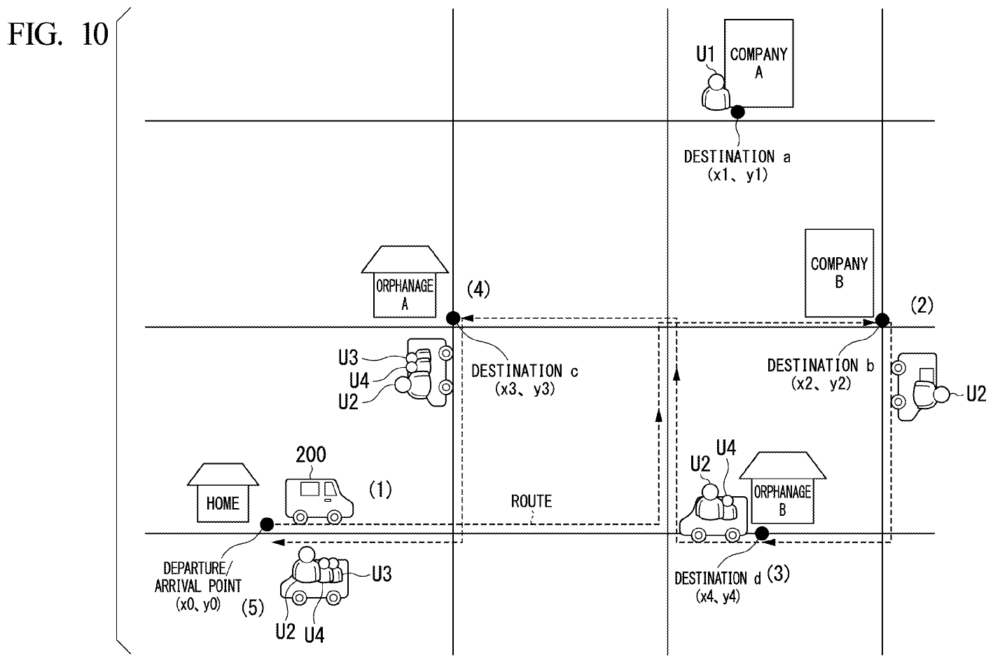

FIG. 10 is a diagram showing an example of vehicle control with travel schedule ID “D003.” In vehicle control with travel schedule ID “D003,” the vehicle 200 departs from the home in a state in which no user boards at a departure time, and stops at the destination b at which company B is located. The user U2 boards at the destination b, and then the vehicle 200 travels to the destination d and stops. The user U4 boards at the destination d, and then the vehicle 200 travels to the destination c and stops. The user U3 boards at the destination c, and then the vehicle 200 travels to the home and stops after arriving at the home.

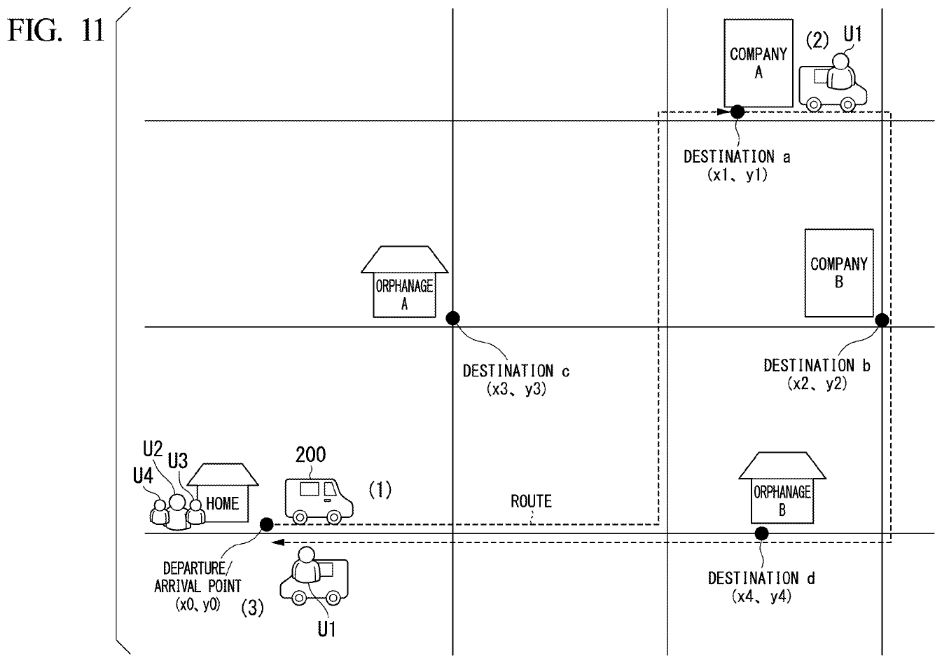

FIG. 11 is a diagram showing an example of vehicle control with travel schedule ID “D004.” In vehicle control with travel schedule ID “D004,” the vehicle 200 departs from the home in a state in which no user boards at a departure time, and stops at the destination a at which company A is located. The user U1 boards at the destination a, and then the vehicle 200 travels to the home and is parked at the garage of the home or the like. The vehicle 200 can transport the users U1 to U4 from the points to the home by traveling on the routes corresponding to travel schedule IDs “D003” and “D004.”

In the above-mentioned travel schedules, when the users U3 and U4 who are infants board the vehicle 200, at least one of the users U1 and U2 who are parents boards together and thus the parent can see a state of the children in the vehicle 200. Accordingly, it is possible to reduce discomfort which is felt by the users U1 and U2 due to boarding of the users U3 and U4 alone. Since the travel schedules are determined such that a parent and a child board together, it is possible to increase a time in which a parent and a child spend together.

When change information of a schedule of a user is acquired by the acquirer 320, the determiner 330 dynamically changes the travel schedule on the basis of the change information. For example, it is assumed that the user U1 can leave company A earlier than scheduled and thus has changed the boarding point departure time of the schedule from “19:30” to “16:00” using the terminal device 100. In this case, the acquirer 320 acquires the date of today and change information of the boarding point departure time of the user U1. Then, the determiner 330 re-determines the travel schedule on the basis of the user schedule information 352 of the users U1 to U4, the inter-user attribute information 353, and the change information. The route instructor 340 transmits the re-determined travel schedule to the vehicle 200.

The vehicle 200 creates a travel plan including route information on the basis of the re-determined travel schedule, and travels by automated driving on the basis of the created travel plan.

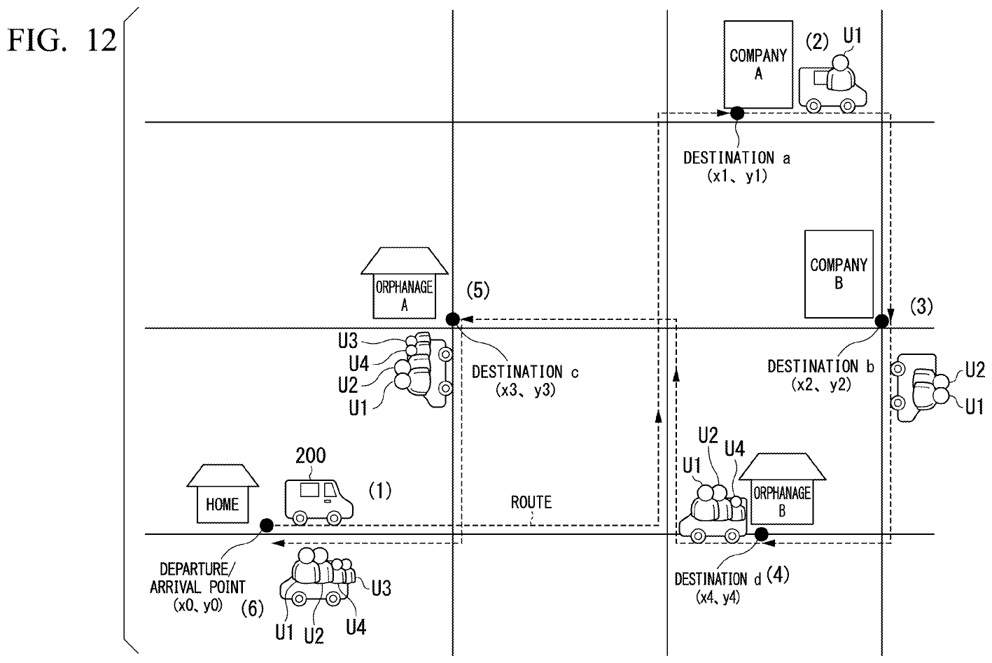

FIG. 12 is a diagram showing an example of vehicle control with changed travel schedules. The example shown in FIG. 12 represents travel schedules which are executed by changing travel schedule IDs “D003” and “D004.” The vehicle 200 departs from the home in a state in which no user boards at a departure time, and stops at the destination a at which company A is located. The user U1 boards at the destination a, and then the vehicle 200 stops at the destination b at which company B is located. The user U2 boards at the destination b, and then the vehicle 200 travels to the destination d and stops. The user U4 boards at the destination d, and then the vehicle 200 travels to the destination c and stops. The user U3 boards at the destination c, and then the vehicle 200 travels to the home and stops after arriving at the home.

In this way, the travel schedule determining device 300 can rapidly change the travel schedule on the basis of change information of a schedule of a user. Accordingly, for example, when an orphanage suddenly notifies a user who is a parent that a child runs a fever, the travel schedule can be changed to a travel schedule corresponding to change information by changing the boarding point departure time for the parent to go to meet the child or adding a destination for the parent to go to a hospital immediately after meeting the child. Accordingly, it is possible to enhance convenience for a user.

[Process Flow]

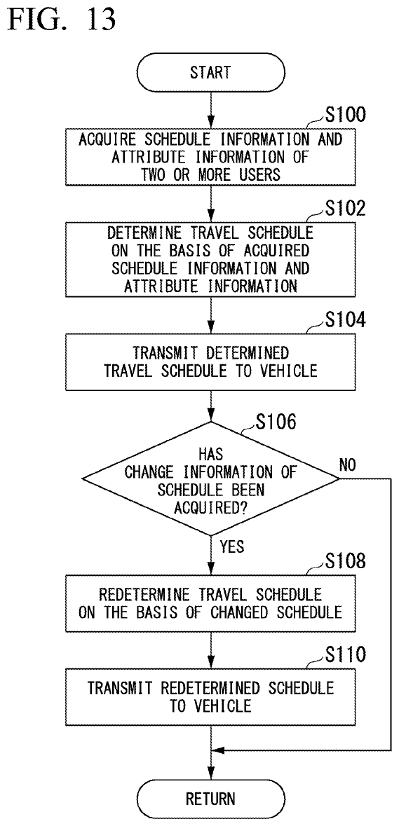

FIG. 13 is a flowchart showing an example of a process flow which is performed by the travel schedule determining device 300 according to the first embodiment. First, the acquirer 320 acquires schedule information of a plurality of users and attribute information indicating a mutual relationship between at least some users out of the plurality of users (Step S100). Then, the determiner 330 determines a travel schedule on the basis of the acquired schedule information and attribute information (Step S102).

Then, the route instructor 340 transmits the determined travel schedule to a vehicle 200 and transmits an instruction to cause the vehicle 200 to travel on a route based on the travel schedule to the vehicle 200 (Step S104).

Then, the acquirer 320 determines whether change information of a schedule of a user has been acquired (Step S106). When change information of a schedule of a user has been acquired, the acquirer 320 re-determines the travel schedule on the basis of the changed schedule (Step S108). Then, the route instructor 340 transmits the re-determined travel schedule to the vehicle 200 and transmits an instruction to cause the vehicle 200 to travel on a route based on the travel schedule to the vehicle 200 (Step S110). As a result, the routine of this flowchart ends.

As described above, with the travel schedule determining device 300 according to the first embodiment, it is possible to determine a travel schedule which matches the mutual relationship between the users. Accordingly, the travel schedule determining device 300 can provide a travel schedule determining service which is suitable for users of a group such as a family.

### Second Embodiment

A second embodiment will be described below. In the second embodiment, a travel schedule in which a user who requires care is permitted to board alone is determined on the basis of attributes of a vehicle 200. Examples of the attributes of a vehicle 200 include information on whether there is a monitoring device that monitors the inside of the vehicle 200, information on whether there is a notification device that notifies a predetermined server device or a terminal of a manager or the like, information on whether a user of the vehicle 200 has a travel license, and information on whether the user holds a travel permission. In the following description, an example in which a monitoring device is mounted in a vehicle 200 will be described.

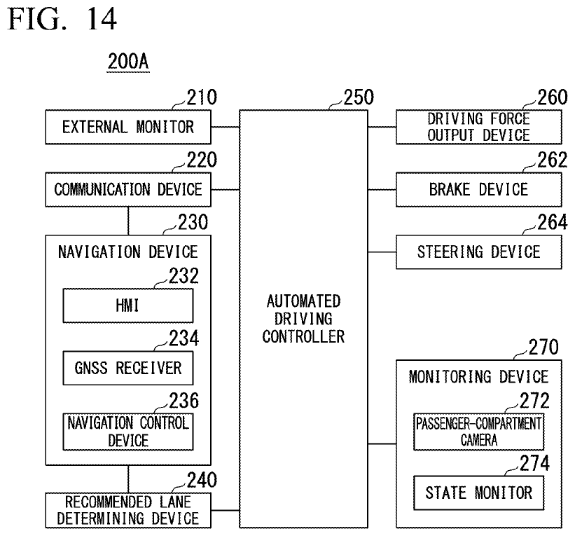

FIG. 14 is a diagram showing a configuration of a vehicle 200A according to the second embodiment. The vehicle 200A includes a monitoring device 270. The functions of the other elements are the same as in the vehicle system 1 according to the first embodiment.

The monitoring device 270 includes, for example, a passenger-compartment camera 272 and a state monitor 274. The passenger-compartment camera 272 images an upper half including a face of a user who sits on a seat in the vehicle 200. The image captured by the passenger-compartment camera 272 is output to the state monitor 274.

For example, the state monitor 274 transmits an image of a user in a passenger compartment captured by the passenger-compartment camera 272 to a terminal device 100 at intervals of a predetermined period via the communication device 220. The state monitor 274 analyzes the image captured by the passenger-compartment camera 272 and determines whether a user is in an abnormal state. When a user is in an abnormal state, the state monitor 274 transmits information indicating that state to the terminal device 100.

The state monitor 274 compares a shape of a feature part (for example, eyes or a mouth) of a user's face included in the captured image with a preset shape of a feature part of a tearful face, and determines that the user is crying when a similarity value therebetween is equal to or greater than a threshold value. The state monitor 274 may determine whether a user included in the captured image is tearful by learning features of users' faces to perform recognition or classification of expression of users using machine learning such as deep learning. When it is determined that a user is tearful, the state monitor 274 determines that the user is in an abnormal state. When it is determined that a user is in a noisy state or does not move for a predetermined time or more, the state monitor 274 may determine that the user is in an abnormal state.

For example, when a monitoring device 270 is mounted in a vehicle 200A to which travel schedule information is to be transmitted, the determiner 330 of the travel schedule determining device 300 determines, for example, a travel schedule in which the users U3 and U4 who are infants are permitted to board alone. Partitions (partitioning parts) for partitioning the passenger compartment to form a private room space for each passenger, or the like, may be provided in the vehicle 200A. Accordingly, it is possible to cut off sights of other passengers and to prevent contact with other passengers. When the partitions are provided in addition to (or instead of) the monitoring device 270 mounted in the vehicle 200, the determiner 330 may determine a travel schedule in which the users U3 and U4 are permitted to board alone.

The monitoring device 270 may perform authentication by an attendant (for example, a nursery teacher) when a user (for example, a kindergarten child) boards, and permit the user's boarding on the basis of a result of authentication. In this case, the monitoring device 270 recognizes an attendant's face from an image captured by the passenger-compartment camera 272 or a camera that images the outside, and permits the user or the user and the attendant to board when the recognized face is a face which has been registered in advance.

The monitoring device 270 may prohibit boarding together on the basis of a mutual relationship between users. For example, when a child is in the vehicle, the monitoring device 270 prohibits another child from boarding or prohibits another (adult) person from boarding. When different families board, the monitoring device 270 may perform monitoring of permitting boarding together only when two or more family members of each family board. When boarding together is prohibited, the monitoring device 270 performs notification indicating prohibition of boarding together, for example, using a display device, a speaker, or the like of the HMI 232 and outputs an instruction to the automated driving controller 250 such that the vehicle 200 does not travel.

As described above, according to the second embodiment, it is possible to determine a travel schedule regardless of whether a boarding user requires care in addition to achieving the same advantageous effects as in the first embodiment. Accordingly, the travel schedule determining device 300 can determine a travel schedule which matches schedules of users when a vehicle in which the monitoring device 270 is mounted is used.

According to the second embodiment, since even a user who requires care can be made to board alone on the basis of attributes of a vehicle 200A, it is possible to further improve convenience for a user. For example, when the monitoring device 270 is mounted in the vehicle 200A, a user who provides care can easily ascertain an image of a user who requires care or information indicating that a user who requires care is in an abnormal state from the terminal device 100 without boarding the vehicle 200.

### Third Embodiment

A third embodiment will be described below. In the third embodiment, functions such as user authentication and vehicle access management are provided on a vehicle 200 side. In the following description, the configuration of a vehicle according to the third embodiment will be described in comparison with the configuration of the vehicle 200 according to the first embodiment.

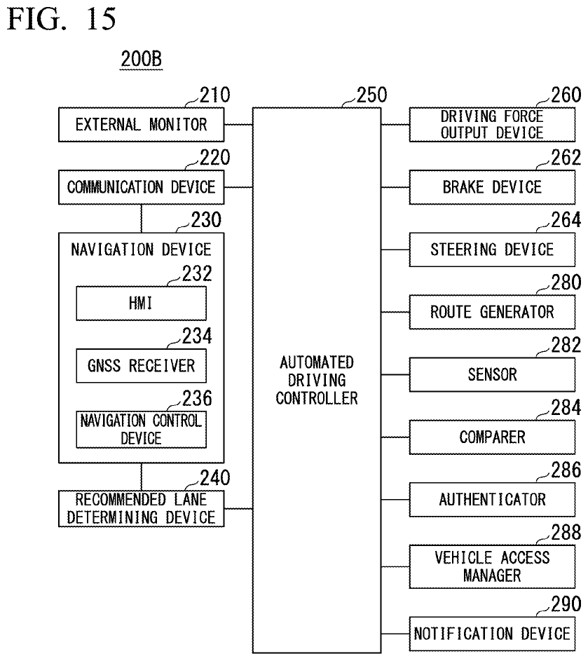

FIG. 15 is a diagram showing the configuration of a vehicle 200B according to the third embodiment. The vehicle 200B according to the third embodiment is different from the vehicle 200 according to the first embodiment, in that it includes a route generator 280, a sensor 282, a comparer 284, an authenticator 286, a vehicle access manager 288, and a notification device 290. Accordingly, the route generator 280, the sensor 282, the comparer 284, the authenticator 286, the vehicle access manager 288, and the notification device 290 will be mainly described in the following description. The above-mentioned functional units are realized, for example, by causing a processor such as a CPU to execute a program (software) stored in a storage device. Some or all of these functional units may be realized in hardware such as an LSI, an ASIC, or a FPGA or may be realized in cooperation of software and hardware. The program may be stored in a storage device (not shown) such as an HDD or a flash memory of the vehicle 200B in advance, or the program may be stored in a detachable storage medium such as a DVD or a CD-ROM and be installed in the storage device by inserting the storage medium into a drive device (not shown).

The route generator 280 creates a travel plan of the vehicle 200B including route information on the basis of a travel schedule acquired by communication with the travel schedule determining device 300. The travel plan may include information such as a vehicle speed, a traveling lane, a temporary stop point, a stop time, and the number of users in a predetermined section in addition to the route information.

The automated driving controller 250 sets an attribute travel plan in which the travel plane generated by the route generator 280 is correlated with the inter-user attribute information 353, and causes the vehicle 200 to travel along a route in the set attribute travel plan. The attribute travel plan is a travel plan including information on in what order users are allowed to board depending on attributes of the users (including articles), services, or the like. The attribute travel plan includes, for example, an occupation plan indicating that parts of the vehicle 200B are occupied by a plurality of users. Accordingly, the vehicle 200 can be made to travel adaptively to a board sharing service or the like. Accordingly, the vehicle 200 can be used for a boarding service, a transportation service, or the like in a spare time of the vehicle 200 and thus it is possible to effectively utilize the vehicle 200.

The sensor 282 is, for example, a reading sensor that reads information stored in a camera sensor or a memory of an integrated circuit (IC) card. The sensor 282 detects information on users of the vehicle 200 as sensor information. Information on users is, for example, user information which is identified from feature information of a face or an article obtained by imaging the face or article of a user who boards using the camera sensor and analyzing the captured image. Information on users may be a travel license or travel permission information of a user who is read from the camera sensor or the memory of the IC card.

The comparer 284 compares the attribute travel plan with user attribute information based on sensor information acquired from the sensor 282 at the time of traveling based on the attribute travel plan under the control of the automated driving controller 250, and determines whether the vehicle travels correctly in accordance with the attribute travel plan. For example, when it is determined that the user attribute information based on the sensor information does not match the attribute travel plan, the notification device 290 may notify a predetermined server device or a terminal of a manager or the like that the information pieces do not match each other via the communication device 220. When it is determined that the user attribute information based on the sensor information does not match the attribute travel plan, the automated driving controller 250 may end travel based on the attribute travel plan or change the attribute travel plan.

The authenticator 286 acquires key information for occupying a part of the vehicle 200B and determines whether authentication of a user corresponding to the acquired key information has been performed successfully on the basis of the acquired key information. Key information is, for example, a travel license or travel permission information of a user which is acquired by the sensor 282. The authenticator 286 determines that authentication has been performed successfully, for example, when the travel license of the user is a license capable of driving the vehicle 200B, and determines that authentication has not been performed successfully when the travel license is not a license capable of driving the vehicle 200B.

The vehicle access manager 288 manages a user's access right to the vehicle 200B. For example, when authentication of the user by the authenticator 286 has been performed successfully, the vehicle access manager 288 permits occupation of at least a part of the vehicle 200B. For example, the vehicle access manager 288 compares the key information acquired by the authenticator 286 with access permission information which is issued by the determiner 330 of the travel schedule determining device 300, and permits occupation of a part of the vehicle 200B when the key information matches the access permission information. When the key information does not match the access permission information, the vehicle access manager 288 resets the attribute travel plan.

The notification device 290 notifies the travel schedule determining device 300 of information on a time (a spare time) in which the attribute travel plan is free (notification information), for example, via the communication device 220 and receives a travel schedule using the spare time from the travel schedule determining device 300. Accordingly, the route generator 280 changes the travel plan on the basis of a new travel schedule which is determined by the travel schedule determining device 300 on the basis of notification information from the notification device 290 and travel permission information which is set by the vehicle 200. The travel permission information is, for example, information indicating that an order such as a service from a third party is accepted by an owner in the spare time. The travel permission information may include information on a spare time including a margin time (a margin) in which only travel based on the original travel plan is performed. When a time when a new travel schedule in which a service from a third party or the like is accepted has been temporarily executed is shorter than the spare time including the margin time which is indicated by the travel permission information, the route generator 280 adds a new travel schedule to the spare time of the original travel plan to change the travel plan. Accordingly, the vehicle 200B side can perform determination of whether an order from a third party is to be accepted and create a new travel plan. The vehicle 200B according to the third embodiment may be applied to the vehicles 200 and 200A according to the first and second embodiment.

As described above, according to the third embodiment, the vehicle 200B side can create a travel plan on the basis of an occupied state of a passenger compartment in addition to achieving the same advantageous effects as in the first embodiment. The attribute travel plan can be reset on the basis of a result of authentication on the vehicle 200B side or the like.

<Application Examples>

Application examples of the vehicle system 1 according to the first to third embodiments will be described below. A vehicle 200 of the vehicle system 1 may be a private vehicle of a user, may be a vehicle which is provided by a service provider, or may be a combination thereof.

For example, when the vehicle 200 is a vehicle which is provided by a service provider, the travel schedule determining device 300 transmits a travel schedule to a vehicle of the service provider. When a user uses a vehicle of the service provider, the user pays a fee, which is calculated on the basis of the number of vehicles used, a traveling distance, a traveling time, the number of persons boarding, the number of times of use of a travel schedule, change of a travel schedule, and the like, to the service provider. The service provider may provide a discount service based on the number of times of use or the use time to the user.

A service provider may receive an advertisement fee from another service provider by causing a vehicle which is used by a user to display an advertisement or the like of the other service provider. When a service provider accepts an order based on an advertisement which is displayed on a vehicle 200 by another service provider, the service provider may receive a fee based on performance from the other service provider.

While embodiments of the invention have been described above, the invention is not limited to the embodiments and can be subjected to various modifications and replacements without departing from the gist of the invention.

For example the travel schedule determining device 300 may be mounted in the vehicle 200.

When the vehicle 200 is a manually driving vehicle, the communicator 310 may communicate with a terminal device of a driver of the vehicle 200 via the network NW.

What is claim is:

1. A travel schedule determining device comprising:
an acquirer that acquires schedule information of a plurality of users and attribute information indicating a mutual relationship between some users out of the plurality of users; and
a determiner that determines a travel schedule of an automated-driving vehicle on the basis of the schedule information of the plurality of users and the attribute information acquired by the acquirer such that a route is correlated with the attribute information.

2. The travel schedule determining device according to claim 1, wherein the determiner determines the travel schedule with reference to the attribute information such that a user who requires care and a user who provides care board the automated-driving vehicle together.

3. The travel schedule determining device according to claim 2, wherein the user who requires care is a child and the user who provides care is a user who is not a child.

4. The travel schedule determining device according to claim 1, wherein the determiner determines the travel schedule such that an article which is loaded by an occupation-permitted user who occupies at least a part of the automated-driving vehicle and an owner of the article are both in the automated-driving vehicle.

5. The travel schedule determining device according to claim 1, wherein the acquirer acquires change information of the schedule information, and
wherein the determiner dynamically changes the travel schedule on the basis of the change information.

6. The travel schedule determining device according to claim 1, wherein the determiner determines the travel schedule on the basis of attributes of the automated-driving vehicle such that boarding of a user who requires care alone in the automated-driving vehicle is permitted.

7. The travel schedule determining device according to claim 1, wherein the determiner generates one or more candidates for the travel schedule, calculates a score based on a waiting time of a user or an arrival delay time for the one or more candidates for the travel schedule, and determines a candidate for the travel schedule on the basis of the calculated score.

8. The travel schedule determining device according to claim 1, further comprising a communicator that communicates with a terminal device of a user,
wherein the determiner generates one or more candidates for the travel schedule,
wherein the communicator transmits the candidates for the travel schedule generated by the determiner to the terminal device, and
wherein the determiner determines the travel schedule on the basis of a result of selection of the travel schedule by the user received from the terminal device using the communicator.

9. An automated-driving vehicle that is communicatively connected to a travel schedule determining device including an acquirer that acquires schedule information of a plurality of users and attribute information indicating a mutual relationship between some users out of the plurality of users and a determiner that determines a travel schedule of the automated-driving vehicle on the basis of the information acquired by the acquirer, the automated-driving vehicle comprising:
a route generator that generates a travel plan including route information on the basis of the travel schedule determined by the travel schedule determining device;
an automated driving controller that sets an attribute travel plan in which the travel plan generated by the route generator and the attribute information are correlated with each other and causes the automated-driving vehicle to travel along a route in the set attribute travel plan;
a sensor that detects the attribute information; and
a comparer that compares the attribute travel plan with the attribute information detected by the sensor when the automated-driving vehicle travels under the control of the automated driving controller.

10. The automated-driving vehicle according to claim 9, wherein the attribute travel plan includes an occupation plan for allowing each of the plurality of users to occupy a part of the automated-driving vehicle.

11. The automated-driving vehicle according to claim 10, further comprising:
an authenticator that acquires key information for occupying a part of the automated-driving vehicle and authenticates a user using the acquired key information; and
a vehicle access manager that permits occupation of at least a part of the automated-driving vehicle when authentication by the authenticator has been performed successfully,
wherein the vehicle access manager permits occupation of a part of the automated-driving vehicle when access permission information acquired by the determiner matches the key information and resets the attribute travel plan when the access permission information does not match the key information.

12. The automated-driving vehicle according to claim 9, further comprising a notification device that notifies the determiner of a time which is not included in the attribute travel plan,
wherein the route generator changes the travel plan on the basis of a new travel schedule which is determined on the basis of notification information transmitted from the notification device and travel permission information which is set for the automated-driving vehicle.

13. A travel schedule determining method causing a computer to perform:
acquiring schedule information of a plurality of users and attribute information indicating a mutual relationship between some users out of the plurality of users; and
determining a travel schedule of an automated-driving vehicle on the basis of the acquired schedule information of the plurality of users and the acquired attribute information such that a route is correlated with the attribute information.

14. A non-transitory computer-readable storage medium that stores a program to be executed by a computer to perform at least:
acquiring schedule information of a plurality of users and attribute information indicating a mutual relationship between some users out of the plurality of users; and
determining a travel schedule of an automated-driving vehicle on the basis of the acquired schedule information of the plurality of users and the acquired attribute information such that a route is correlated with the attribute information.
